(19) United States
(12) Patent Application Publication
(10) Pub. No.: US 2006/0292928 A1
(43) Pub. Date: Dec. 28, 2006

(54) Electrical connector

(76) Inventors: John R. Morello, Warren, OH (US); William G. Strang, Warren, OH (US); Edward M. Bungo, Cortland, OH (US)

Correspondence Address: DELPHI TECHNOLOGIES, INC., M/C 480-410-202, PO BOX 5052, TROY, MI, 48007, US

(21) Appl. No.: 11/159,907

(22) Filed: Jun. 23, 2005

(51) Int. Cl. H01R 13/40

(52) U.S. Cl. 439/595

(57) ABSTRACT

An electrical connector includes a connector body and an electrical terminal. The connector body has a terminal-receiving cavity formed therein. The cavity is defined in part by a wall. A locking member extends from the wall into the cavity. A flexible beam extends into the cavity opposite the wall. A cantilevered terminal stabilizing member extends from the flexible beam into the cavity. When the terminal is received in the cavity so that the flexible beam abuts the terminal biasing the terminal towards the wall and the locking member engages the terminal preventing the terminal from backing out of the cavity through the opening, the terminal stabilizing member abuts the terminal resisting rotational movement of the terminal within the cavity.

### TECHNICAL FIELD

This invention relates to an electrical connector, and more particularly to an electrical connector having a terminal retained in a terminal-receiving cavity of a connector body.

### BACKGROUND OF THE INVENTION

It is common for an electrical connector to include a connector body forming a cavity for receiving a terminal. It is also common for such electrical connectors to incorporate one or more flexible locking features for retaining a terminal within such a cavity of a connector body. Such locking features may be formed integrally with the terminal, the connector body, or both. While the use of such features provides many benefits, incorporation of flexible locking tangs or fingers can complicate the manufacturing processes, sometimes requiring separate molding and subsequent assembly of multiple parts and often resulting in increased size and complexity of the finished connectors. Additionally, flexible locking members may become inadvertently disengaged otherwise permit the unintended disengagement of a terminal from a connector body.

U.S. Pat. No. 5,980,318 granted to Morello, et al. Nov. 9, 1999, which is assigned to the assignee of the present invention, discloses an electrical connector having such flexible locking structures. For example, Morello discloses a terminal-receiving cavity defined in part by a rigid floor wall that has a rigid lock nib that extends upwardly from the rigid floor wall into the terminal-receiving cavity. The connector body receives a terminal in each terminal-receiving cavity. A flexible beam opposes the rigid floor wall and extends into the terminal-receiving cavity overlying the rigid floor. The flexible beam engages a top surface of a terminal received in the cavity, thereby biasing the terminal toward the floor so that the terminal engages the lock nib. A ceiling wall may also include a terminal hold down bump extending toward the rigid floor wall at a location generally opposite the rigid lock nib. The terminal hold down bump is configured to engage the terminal so as to bias it away from the flexible beam as the terminal is inserted into the connector, thus providing a deflection point for the flexible beam while enabling low frictional forces that resist insertion. In addition, each terminal may have a recess defined in part by a rigid lock bar that is attached to side walls of the terminal. The rigid lock nib is disposed in the terminal recess when the terminal is fully seated in the terminal cavity with the rigid lock bar engaging the rigid lock nib to prevent the seated terminal from being pulled out of the terminal cavity.

Unfortunately, when a seated terminal is pulled by an attached lead, the terminal may translate or rotate within the cavity. In extreme cases, when a terminal is pulled with a sufficient force, the terminal, including a locking edge, may also deform or may be damaged. As a result, the terminal and lock nib may fail to suitably engage one another, and it may become possible to withdraw the terminal from the cavity with an unacceptably low disengagement force. For at least these reasons, there remains a need for an electrical connector which resists rotation of a terminal seated within the connector and retains the terminal with a relatively high terminal retention force yet enables the terminal to be inserted with a relatively low insertion force.

### SUMMARY OF THE INVENTION

The object of the present invention is to provide an improved electrical connector of the type in which a terminal engages a terminal cavity of a connector body so as to prevent the terminal from being pulled out of the connector body.

This invention provides an electrical connector having an improved terminal retention arrangement preferably an arrangement where the terminal pull-out resistence increases substantially as the terminal pull-out force is increased.

In one aspect, a feature of the invention is that a connector body having a cavity for accommodating a terminal includes a resilient member extending into the cavity and abutting a first portion of the terminal to bias the terminal towards a wall of the cavity. A cantilevered member extends from the resilient member into the cavity and abutta a second portion of the terminal to resist rotational movement of the terminal within the cavity, thereby substantially increasing terminal pull-out resistence.

In another aspect, a feature of the invention is that a locking member and a flexible beam terminal stabilizing member extend into a terminal cavity. A flexible beam is secured, at first and second ends of the beam, to a wall of the cavity. The terminal stabilizing member extends from the flexible beam into the cavity, and the flexible beam is configured so that, when the terminal is received in the cavity, the flexible beam abuts the terminal, thereby biasing the terminal toward a wall of the cavity. The locking member engages the terminal so as to prevent the terminal from backing out of the cavity through the opening, and the terminal stabilizing member abuts the terminal so as to resist rotational movement of the terminal within the cavity.

In an exemplary embodiment, an electrical connector includes an insulative connector body and a conductive terminal, the terminal having a first end, a second end for attachment to a wire, and a terminal body between the ends. The insulative connector body has first and a second surfaces defining a recess and includes a rigid lock edge formed in the second surface. The connector body has a front and rear faces and defines a cavity for receiving the terminal. In an exemplary embodiment, the rear face includes a first opening for receiving the terminal and enabling the terminal to enter the cavity. The front face also includes a second opening configured to provide access to the cavity and to expose the terminal for electrical contact with a mating element when the terminal is seated in the cavity. A rigid lock nib extends from a first inner wall into the terminal-receiving cavity, and a flexible beam extends into the terminal receiving cavity opposite the first inner wall.

In an exemplary embodiment, a cantilevered member for stabilizing the terminal extends from the flexible beam into the terminal-receiving cavity so as to defines a concavity located between a side of the cantilevered terminal stabilizing member and the flexible beam. In accordance with this embodiment, the flexible beam engages a first portion of the first surface of the terminal when the terminal is received in the terminal-receiving cavity so as to bias the terminal toward the first inner wall. In addition, the lock nib is received in the recess so that the lock edge engages the lock nib preventing the terminal from being inadvertently withdrawn from the terminal receiving cavity through the second opening, and the terminal stabilizing member abuts a second portion of the first surface of the terminal resisting rotational movement of the terminal within the cavity to provide improved terminal retention.

While each of the above features results in improved terminal retention, it is preferable to include a plurality of these features for suppressing relative movement between a connector body and a terminal, reducing terminal insertion forces, and improving terminal retention.

These and other features and advantages of the present invention will be apparent from the following brief description of the drawings, detailed description, claims, and appended drawings.

### BRIEF DESCRIPTION OF THE DRAWINGS

The above-mentioned features of the present invention can be more clearly understood from the following detailed description considered in conjunction with the following drawings, in which like numerals represent like elements and in which:

FIG. 1 is an exploded partially sectioned perspective view of an electrical connector in accordance with the present invention;

FIG. 2 is a sectioned perspective view of an electrical connector in accordance with the present invention;

FIG. 3 is a perspective view of a female terminal that is part of the electrical connector shown in FIG. 1;

FIG. 4 is an end view of an electrical connector in accordance with the present invention;

FIG. 5 is a cross-sectional view of an electrical connector of FIG. 4 taken along sectional lines 4-4; and

FIG. 6 is a cross-sectional view of illustrating an aspect of the present invention.

### DETAILED DESCRIPTION OF THE PREFERRED EMBODIMENT

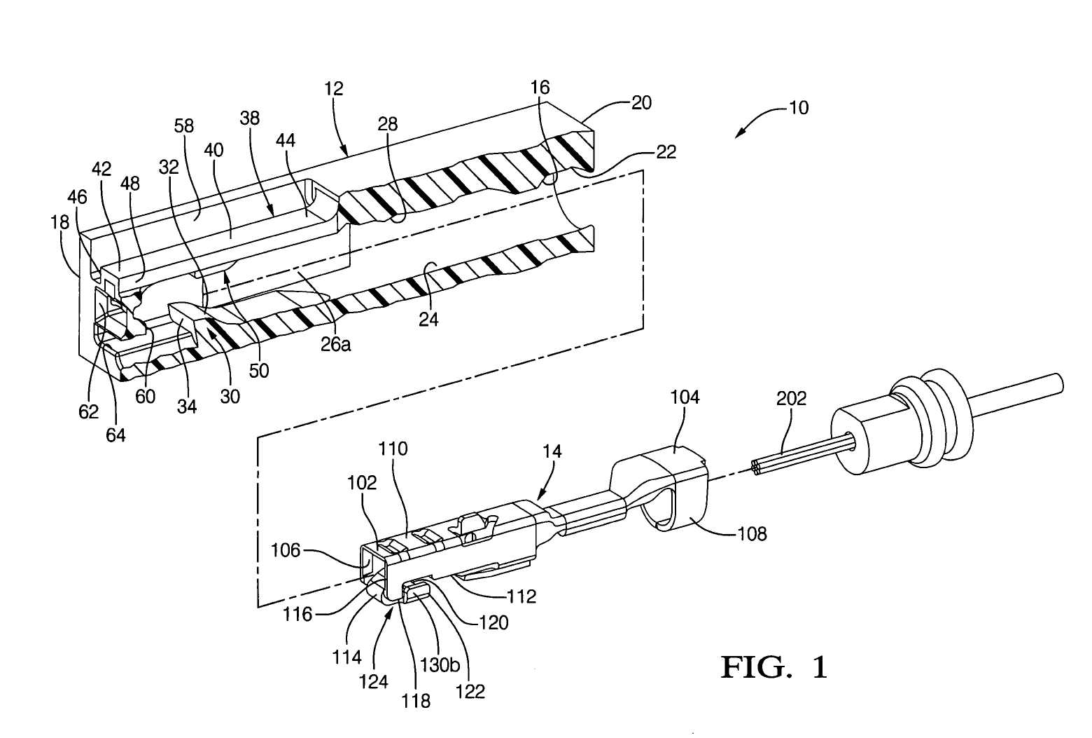

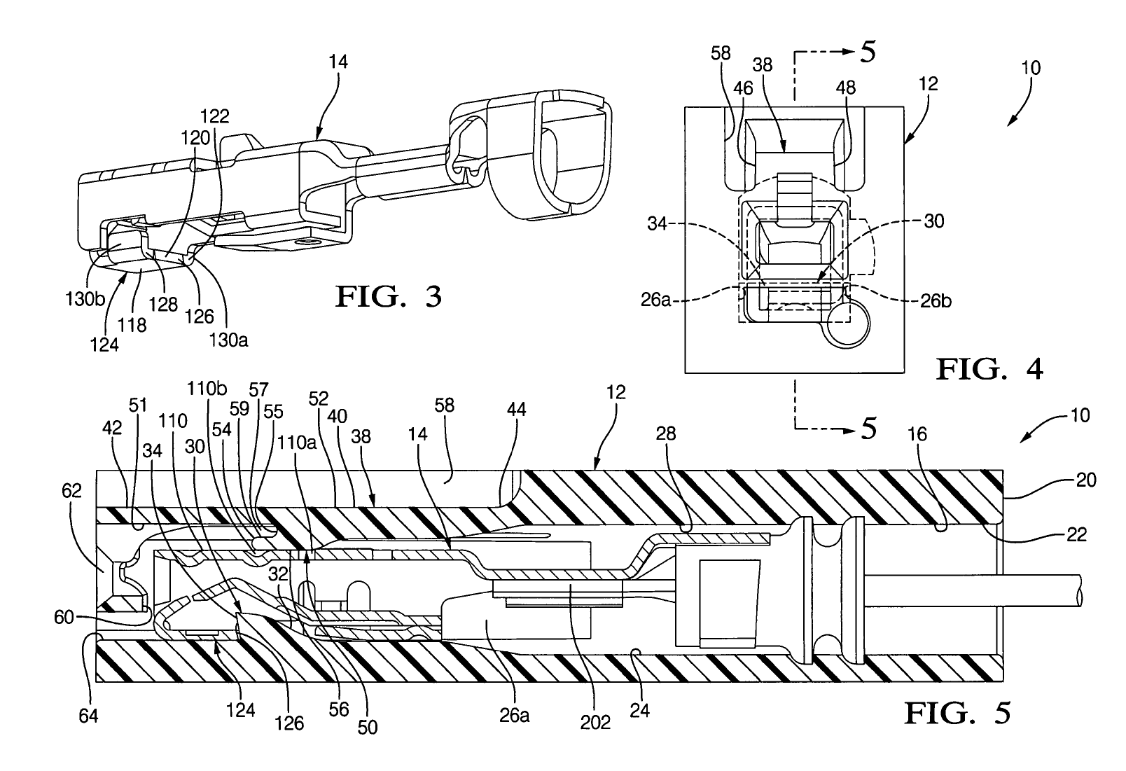

FIGS. 1-6 illustrate an exemplary embodiment of an electrical connector 10 according to the present invention. Electrical connector 10 includes an insulative connector body 12 and a conductive female terminal 14. Connector body 12 is preferably made from a synthetic resin such as an-unfilled polyester. Connector body 12 has a first or terminal-receiving cavity 16 formed therein. Connector body 12 is constructed and arranged for receiving terminal 14 in terminal receiving cavity 16, as further described below. Connector body 12 includes a front face 18 and an opposed rear face 20. Rear face 20 has a first opening 22 aligned with terminal receiving cavity 16 to facilitate insertion of electrical terminal 14 into terminal receiving cavity 16 through first opening 22.

Terminal receiving cavity 16 is defined in part by a rigid floor or first wall 24. Opposed upright second and third walls 26a, 26b extend transversely from floor 24. Terminal-receiving cavity 16 is further defined by a ceiling or fourth wall 28 extending between the opposed second and third walls 26a, 26b. Rigid floor 24 is attached along at least two edges and preferably along all (four) edges to prevent movement or flexing of floor 24.

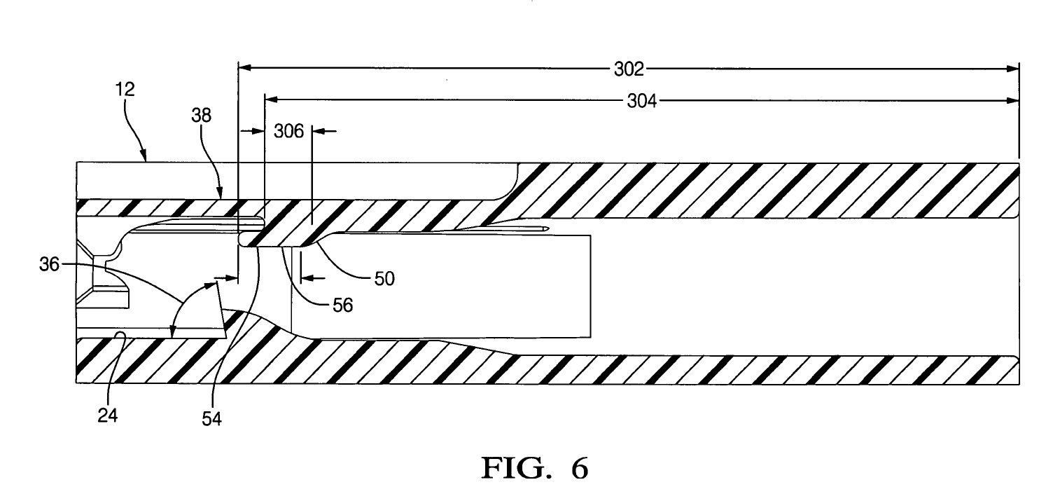

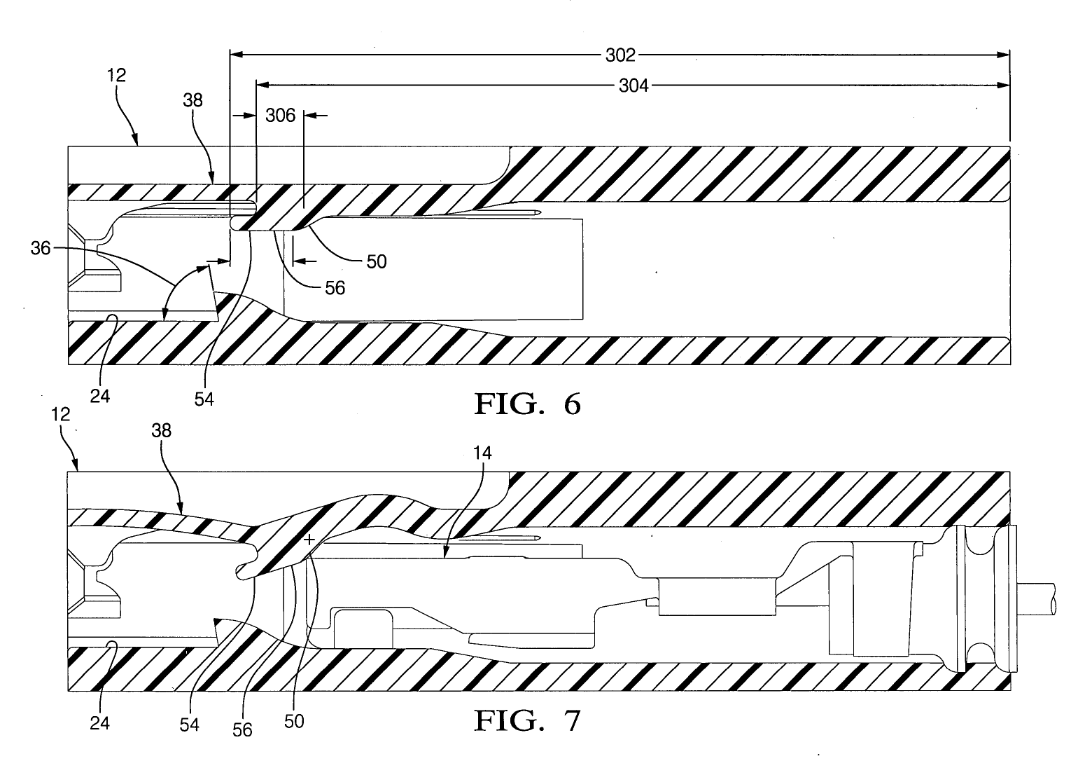

A rigid lock nib 30 extends upwardly from rigid floor 24 into terminal receiving cavity 16. Rigid lock nib 30 includes a sloped surface 32 that starts nearest rear face 20 of connector body 12 and terminates at a rigid lock shoulder 34 on a portion of lock nib 30 formed nearest front face 18. As shown on FIG. 6, rigid lock shoulder 34 is oriented at an acute angle 36 with respect to rigid floor 24 such that rigid lock shoulder 34 faces towards both front face 18 and rigid floor 24.

As shown on FIG. 5, rigid lock nib 30 extends between second and third walls 26a, 26b and is attached to each wall 26a, 26b. A flexible beam 38 extends from ceiling 28 into terminal receiving cavity 16 opposite rigid floor 24. Flexible beam 38 includes a bridge portion 40 extending between first and second ends 42, 44. First end 42 is attached to front face 18 of connector body 12. Second end 44 is attached to rear face 20 of connector body 12 via ceiling 28. Flexible beam 38 is preferably attached only at the first and second ends 42, 44 and not along sides 46, 48 of the beam 38.

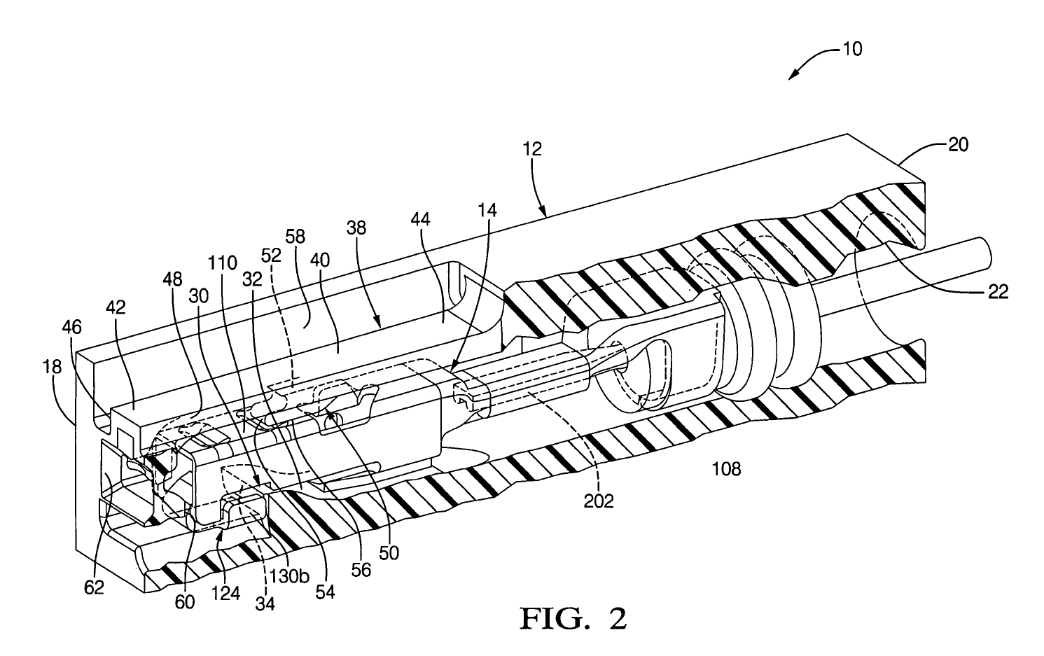

Flexible beam 38 further includes a protuberance or terminal hold down bump 50 protruding from a terminal receiving cavity facing surface 51 of bridge portion 40 and extending towards rigid floor 24 at a location generally opposite rigid lock nib 30. Terminal hold down bump 50 provides a deflection point for flexible beam 38. As shown on FIG. 2, a terminal hold down bump base 52 is defined at the location where terminal hold down bump 50 extends from bridge portion 40.

A substantially rigid cantilevered terminal stabilizing member 54 projects from terminal hold down bump 50 and extends towards front face 18 of connector body 12. In a cross-sectional view terminal stabilizing member 54 resembles a toe extending generally in parallel with respect to bridge portion 40 of flexible beam 38. Terminal hold down bump 50 and terminal stabilizing member 54 together define a terminal contact surface 56. Terminal hold down bump 50, terminal stabilizing member 54 and bridge portion 40 of flexible beam 38 form a concave region 55 defining a space 57. Space 57 is provided between a non-contact side or surface 59 of terminal stabilizing member 54 and terminal receiving cavity facing surface 51 of bridge portion 40. Space 57 isolates side 59 of terminal stabilizing member 54 from flexible beam 38 minimizing the impact of terminal stabilizing member 54 on the resiliency of flexible beam 38. A second cavity 58 is provided in connector body 12 above flexible beam 38 to facilitate movement or deflection of beam 38.

In an exemplary embodiment electrical terminal 14 is a one piece metal member of relatively thin gauge metal stock and comprises, in general, a forward, generally boxed shaped main body portion 102 and a rearward conductor engaging portion 104. Main body portion 102 has an opening 106 for receiving a mating element (not shown) such as a male terminal. Conductor engaging portion 104 is constructed for attachment to a wire 202, and includes a metal crimp section 108. Body portion 102 has a top surface 110, and a bottom surface 112. Body portion 102 includes a lock member 114 extending from a forward end 116 of body portion 102.

Lock member 114 includes a flat portion 118 which extends to a rigid lock edge 120 at a distal end 122. Lock edge 120 engages rigid lock shoulder 34 of lock nib 30 when terminal 14 is seated in connector body 12 as further described below. Bottom surface 112 defines a recess or aperture 124 for receiving rigid lock nib 30. Rigid lock edge 120 includes a wedge shaped edge portion 126 and a blunt portion 128 formed on distal end 122 of lock member 114 for engaging rigid lock shoulder 34 when terminal 14 is seated in terminal receiving cavity 16 as further described below. Lock member 114 further includes opposing sides 130a, 130b extending upwardly from opposing sides of flat portion 118. Each side 130a, 130b has a swept forward profile when viewed from the other side 130a, 130b. Each side 130a, 130b engages rigid lock shoulder 34 of lock nib 30 when terminal 14 is seated in connector body 12, as further described below.

To assemble connector 10, first end 102 of terminal 14 is inserted through first opening 22 in rear face 20 and into terminal receiving cavity 16. First end 102 of terminal 14 engages lock nib 30 and terminal 14 rides up sloped surface 32 lifting terminal 14 off of rigid floor 24. As terminal 14 is riding up sloped surface 32 of lock nib 30, top surface 110 engages terminal hold down bump 50 and flexible beam 38 flexes upward into second cavity 58 to accommodate the movement of terminal 14 between the lock nib 30 and terminal hold down bump 50. Terminal stabilizing member 54 follows flexible beam 38 as it deflects.

The deflection of flexible beam 38 during terminal 14 insertion causes terminal stabilizing member 54 to rotate from an initial orientation into alignment with incoming terminal 14. As terminal 14 is pushed forward further into terminal receiving cavity 16, recess or aperture 124 overlies rigid lock nib 30 at which point the resilient force of flexible beam 38 applied to top surface 110 of terminal urges terminal 14 against rigid floor 24 returning terminal stabilizing member 54 to its initial orientation and seating terminal 14 in terminal receiving cavity 16 of connector body 12.

In this seated position, terminal hold down bump 50 portion of flexible beam 38 contacts a first portion 110a of top surface 110 of terminal 14 biasing terminal 14 toward rigid floor 24. Rigid lock shoulder 34 of lock nib 30 engages rigid lock edge 120 preventing terminal 14 from backing out of (or being inadvertently withdrawn from) terminal receiving cavity 16 through first opening 22. And, cantilevered terminal stabilizing member 54 engages a second portion 110b of top surface 110 of terminal 14 resisting rocking or rotational movement of terminal 14 within terminal receiving cavity 16.

A stop 60, such as the inside wall of front face 18, is provided in connector body 12 to prevent terminal 14 from moving in a forward direction. A male terminal blade (not shown) or shaft may be inserted through a second opening 62 in front face 18 of the connector body 12 and into opening 106 in first end 102 of terminal 14. A third opening 64 is provided in front face 18 of connector body 12 and communicating with terminal receiving cavity 16 so that a tool (not shown) may be inserted therethrough to lift up terminal 14 so that lock edge 120 is above lock nib 30 thereby allowing terminal 14 to be removed through first opening 22 in rear face 20.

Referring to FIG. 6, terminal contact surface 56 extends to a first distance 302 away from first opening 22, terminal hold down bump base 52 extends to a second distance 304 away from said first opening 22, the first distance 302 being greater than the second distance 304. Consequently, in an exemplary embodiment, terminal hold down bump 50 provides a deflection point at an optimal location near the center of flexible beam 38 to minimize the force required to insert terminal 14 into terminal receiving cavity 16 and cantilevered terminal stabilizing member 54 projects forwardly from terminal hold down bump 50 to resist rotational movement of terminal 14.

Referring to FIG. 6, in an exemplary embodiment, terminal hold down bump base 50 has a cross-sectional 306 having an area that is less than the area of terminal contact surface 56. This is advantageous because a small base generally enables a more flexible, less rigid beam thereby enabling a low terminal insertion force. While a large terminal contact surface 56 area generally provides greater support for terminal 14 and greater terminal stability.

As indicated above, the improved terminal retention features are possible in the invention; any one of which results in terminal retention improvement. However, it is preferable to a plurality of the improved terminal retention features and more preferable to use all of the improved terminal retention features of the invention.

The exemplary embodiments shown and described above are provided merely by way of example and are not intended to limit the scope of the invention in any way. Exemplary ratios, materials and construction techniques are illustrative only and are not necessarily required to practice the invention. It is intended that the scope of the present invention herein disclosed should not be limited by the particular disclosed embodiment shown and described above, but should be defined only by a fair reading of the claims that follow.

Further modifications and alterations may occur to others upon reading and understanding the specification. For example, in an exemplary embodiment terminal 14 is a one piece metal member. However, an electrical connector according to the present invention may include a terminal comprised of more than one piece. The specification is intended to include all such modifications and alterations insofar as they come within the scope of the invention.

1: A connector body having a cavity for accommodating a terminal therein, comprising:
a resilient member extending into said cavity from a first surface of said connector body, said resilient member configured for abutting said terminal at a first location so as to bias said terminal towards a second surface, said resilient member fixed at one end to said first surface and fixed at an opposite end to a third surface of said connector body to form a bridge structure; and
a cantilevered member extending from a midspan position on said resilient member into said cavity for abutting said terminal at a second location so as to resist rotational movement of said terminal within said cavity.

2: The connector body as recited in claim 1 wherein said cantilevered member and said resilient member form a concavity, said concavity defining a space providing isolation between a side of said cantilevered member and said resilient member.

3: The connector body as recited in claim 2 wherein said resilient member comprises a flexible beam having first and second ends that are fixed to said connector body.

4: The connector body as recited in claim 3 wherein said flexible beam comprises a protuberance for abutting said terminal at said first location, said cantilevered member projecting from said protuberance.

5: The connector body as recited in claim 4 wherein said cantilevered member is substantially rigid.

6: The connector body as recited in claim 5 wherein said cantilevered member extends generally in parallel with respect to said flexible beam.

7: The connector body as recited in claim 6 wherein said cavity has an opening through which said terminal may be inserted, a rigid lock nib extending from said surface for engaging said terminal so as to resist said terminal from backing out of said cavity through said opening.

8: An electrical connector comprising:
a conductive terminal; and
a connector body having a terminal receiving cavity formed therein, said cavity being defined in part by a wall, said cavity being provided with an opening through which said terminal is inserted, a locking member and a flexible beam each extending into said cavity, a cantilevered terminal stabilizing member extending from said flexible beam into said cavity, wherein said terminal being received in said cavity so that said flexible beam abuts a first portion of said terminal biasing said terminal towards said wall, said locking member engages a second portion of said terminal preventing said terminal from backing out of said cavity through said opening, and said terminal stabilizing member abuts a third portion of said terminal resisting rotational movement of said terminal within said cavity, wherein said connector body and said terminal are constructed and arranged so that, during an insertion of said terminal into said cavity, said terminal causes said flexible beam to deform away from said wall, and said terminal stabilizing member follows said flexible beam as said flexible beam deforms.

9: The electrical connector as recited in claim 8 wherein said flexible beam is secured at first and second ends and is deformable between said ends.

10: The electrical connector as recited in claim 9 wherein said terminal stabilizing member comprises a nib extending from a first surface of said flexible beam into said terminal receiving cavity, said nib having a non-contact surface facing said flexible beam, said non-contact surface and said first surface of said flexible beam defining a space isolating a side of said nib from said flexible beam.

11: The electrical connector as recited in claim 10 wherein said flexible beam comprises a bridge extending between said first and second ends, and a protuberance, said protuberance extending from said bridge into said cavity for abutting said first portion of said terminal.

12: The electrical connector as recited in claim 11 wherein said nib extends from said protuberance.

13: The electrical connector as recited in claim 12 wherein said protuberance connects to said bridge at a protuberance base, said protuberance and said nib together defining a terminal hold down surface, said terminal hold down surface extending to a first distance away from said opening, said protuberance base extending to a second distance away from said opening, said first distance being greater than said second distance.

14: An electrical connector comprising:
a conductive terminal having a first end, a second end for attachment to a wire, and a body portion extending between said ends, said body portion having a first surface, and an opposing second surface including a recess defined therein, said recess being defined in part by a rigid lock edge in said second surface; and
an insulative connector body having a terminal receiving cavity formed therein, said cavity being defined in part by a first wall of said connector body, said connector body having a front face and an opposed rear face, said cavity being provided with a first opening in said rear face for receiving said terminal therethrough, said cavity being further provided with a second opening in said front face to expose said terminal for electrical contact with a mating element, a lock nib extending from said first wall into said cavity, a flexible beam extending into said cavity opposite said first wall, a cantilevered terminal stabilizing member extending from said flexible beam into said cavity forming a concave region defining a space between a side of said cantilevered terminal stabilizing member and said flexible beam, said terminal being received in said cavity so that said flexible beam engages a first portion of said first surface of said terminal biasing said terminal towards said first wall, said lock nib is received in said recess so that said lock edge engages said lock nib preventing said terminal from being inadvertently withdrawn from the terminal receiving cavity through said second opening, and said terminal stabilizing member abuts a second portion of said first surface of said terminal resisting rotational movement of said terminal within said cavity, wherein said flexible beam is constructed and arranged to be deformed by said terminal as said terminal is inserted into said cavity, and said flexible beam and said terminal stabilizing member are constructed and arranged so that said terminal stabilizing member rotates relative to the connector body as said flexible beam deforms in response to insertion of said terminal.

15: The electrical connector as recited in claim 14 wherein said flexible beam comprises a terminal hold down bump extending into said cavity at a location generally opposite said lock nib.

16: The electrical connector as recited in claim 15 wherein said lock nib comprises a rigid lock nib extending from said first wall.

17: The electrical connector as recited in claim 16 wherein said cantilevered terminal stabilizing member comprises a substantially rigid second nib projecting from said terminal hold down bump.

18: The electrical connector as recited in claim 17 wherein said cantilevered terminal stabilizing member extends generally toward said front face of said connector body.

19: The electrical connector as recited in claim 18 wherein said flexible beam is secured at first and second ends and detached along opposed sides.

20: The electrical connector as recited in claim 19 wherein said cavity being further defined in part by opposing second and third walls extending transversely from said first wall, said lock nib being attached to each of said second and third walls.

21: The electrical connector as recited in claim 20 wherein said lock nib comprises a rigid lock shoulder oriented at an acute angle with respect to said first wall, said lock shoulder facing towards said front face and said first wall, wherein said lock shoulder engages said lock edge.

22. The connector body as recited in claim 1, said cantilevered member fixed to said resilient member at a mid-span position, wherein, in response to insertion of a terminal, said resilient member is configured to deform away from said second surface in such a way as to cause said cantilevered member to rotate relative to the connector body as said resilient member deforms.
